(19) United States
(12) Patent Application Publication
(10) Pub. No.: US 2006/0083027 A1
(43) Pub. Date: Apr. 20, 2006

(54) Double side backlight module

(76) Inventors: Te-Neng Lin, Kaohsiung City (TW); Chin-Yung Liu, Taoyuan Hsien (TW)

Correspondence Address: Te-Neng Lin, 235 Chung - Ho, Box 8-24, Taipei, TW

(21) Appl. No.: 10/967,804

(22) Filed: Oct. 19, 2004

(51) Int. Cl. F21V 7/04

(52) U.S. Cl. 362/615; 362/26; 362/561

(57) ABSTRACT

A double side backlight module comprising: a backlight module installed between a first display screen and a second display screen. The backlight module having the following elements; a least one light source; a light guiding plate having one lateral side adjacent to the at least one light source; the light guiding plate having at one pattern surface near the first display screen or the second display screen; at least one first light-enhancing sheet installed between light guiding plate and the first display screen and at least one light-enhancing sheet between the light guiding plate and the second display screen. Between the light guiding plate and the first display screen or second display screen can be installed with at least one lower diffusion sheet.

### FIELD OF THE INVENTION

The present invention relates to backlight modules, and particularly to a double side backlight module, wherein the backlight module of the present invention has a pattern surface which is used to replace a reflecting sheet. Thus the loss of light is reduced and the two liquid crystal modules have sufficient light strength. Thereby the sizes of the two liquid crystal modules may be different, the volumes of the two may be larger and cost can be reduced.

### BACKGROUND OF THE INVENTION

Backlight modules are important components to LCD (liquid crystal display) panels. Since liquid crystals will not emit light, a backlight module is used to provide sufficient and uniform light to the panel so that image can be displayed normally.

Thereby, backlight modules are important components in determination of the performance of the LCD panels. There are two kinds of the backlight modules are used currently. One has single one light source (currently, the cool cathode fluorescent light is used) which is placed at one lateral side of the modules, called as lateral lighting backlight modules. The other has plurality of light sources which are placed below the panels, called as directly lighting backlight devices. In the directly lighting backlight device, most of the cool cathode fluorescent lights have straight lamp tubes.

Referring to FIG. 1, a lateral side of the backlight module has a light source 90 and a light guiding plate 91. The light source 90 is at a lateral side of the light guiding plate 91. The light from the light guiding plate 91 is guided to the front and rear sides of the light guiding plate 91 by the light guiding plate 91. Thereby the main display 92 and sub-display 93 at the front and back sides of the backlight module have sufficient illumination. A lower diffusion sheet 94 and a light-enhancing sheet 95 are installed between the light guiding plate 91 and the main display 92. The lower diffusion sheet 94 had the effect of uniformly distributing light so that no image of reflecting light is presented on the main display 92. The effect of the light-enhancing sheet 95 is to focus light so as to increase the illumination of the backlight module. A further lower diffusion sheet 94 and a further light-enhancing sheet 95 are installed between the light guiding plate 91 and the sub-display 93, which have the same effects as those between the light guiding plate 91 and the main display 92. A semi-transparent reflecting sheet 96 is placed between the light guiding plate 91 and the lower diffusion sheet 94 of the sub-display 93 for reflecting part of light toward the main display 92. In general, the size of the main display 92 is greater than that of the sub-display 93 and need a great light intensity. The reflecting sheet 96 serves to achieve the object of adjusting the ratio of the light from the main display 92 and the sub-display 93.

However, under consideration of thickness and power consumption of the double side backlight module, the intensity of this prior art is finite. The reflecting sheet and lower diffusion sheet make more power being consumed so that if the sub-display 93 is larger, the light intensity will be deficient. Thereby the size of the sub-display 93 is small. Moreover, the prior art is thick so that the size is great. This is suitable in use of the backlight module.

### SUMMARY OF THE INVENTION

Accordingly, the primary object of the present invention is to provide a double side backlight module, wherein the backlight module of the present invention has a pattern surface which is used to replace a reflecting sheet. Thus the loss of light is reduced and the two liquid crystal modules have sufficient light strength. Thereby the sizes of the two liquid crystal modules may be different, the volumes of the two may be larger and cost can be reduced.

To achieve above objects, the present invention provides a double side backlight module. The backlight module comprises: a backlight module installed between a first display screen and a second display screen. The backlight module has the following elements; at least one light source; a light guiding plate having one lateral side adjacent to the at least one light source; the light guiding plate having at one pattern surface near the first display screen or the second display screen; at least one first light-enhancing sheet installed between light guiding plate and the first display screen and at least one light-enhancing sheet between the light guiding plate and the second display screen. Between the light guiding plate and the first display screen or second display screen can be installed with at least one lower diffusion sheet.

The various objects and advantages of the present invention will be more readily understood from the following detailed description when read in conjunction with the appended drawing.

### BRIEF DESCRIPTION OF THE DRAWINGS

FIG. 1 is a cross sectional view of the prior art.

FIG. 2 is a cross sectional view about the double side backlight module of the present invention.

FIG. 3 is an enlarged cross sectional view of the double side backlight module of the present invention.

FIG. 4 is a cross sectional view of the second embodiment of the present invention.

FIG. 5 is a cross sectional view about the second embodiment of the present invention.

FIG. 6 is a cross sectional view about the fourth embodiment of the present invention.

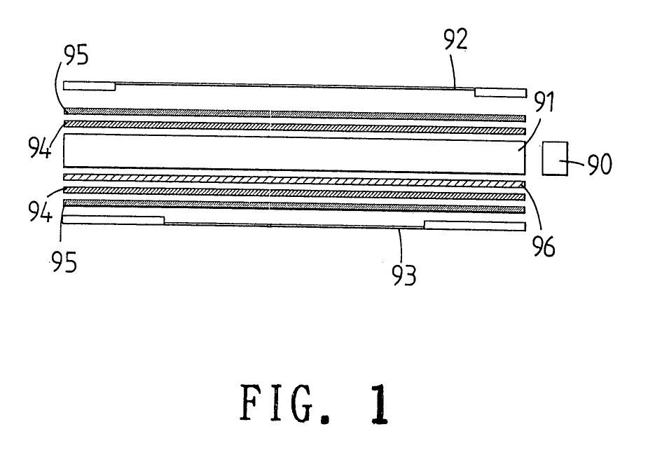

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

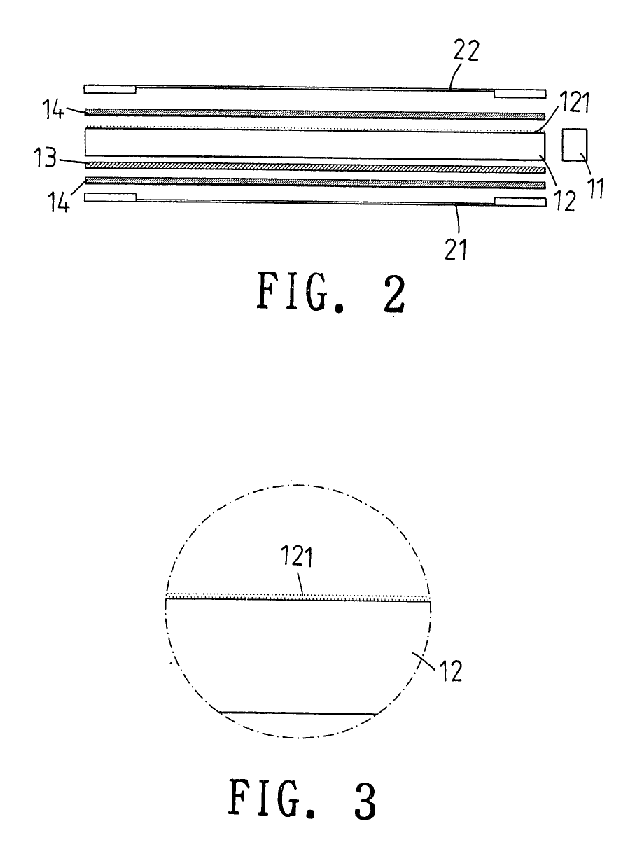

Referring to FIGS. 2 and 3, the double side backlight module of the present invention is illustrated. The present invention includes the following elements.

The backlight module of the present invention is installed between two liquid crystal modules. The liquid crystal modules can be made of optic films. The film can be sealed by light shield cloth (not shown) so as to prevent light from draining out.

A first display screen 21 is at a front end and a second display screen 22 is at a backside.

A backlight module is between the first display screen 21 and the second display screen 22. The backlight module could supply light with sufficient light strength.

Sizes of the first display screen 21 and second display screen 22 may be different despite the strength of the backlight module.

The backlight module has the following elements.

At least one light source 11 is selected form one of a cool cathode fluorescent light source (CCFL), light emitting diodes (LED), and an electric luminescence display (ELC). The light source 11 is arranged at one lateral side.

A light guiding plate 12 has one lateral side adjacent to the at least one light source 11. The light guiding plate 12 serves to guide light from the light source 11 to the first display screen 21 and second display screen 22. The light guiding plate 12 has a pattern surface 122 (which may be a V cut pattern surface, a U shape pattern surface, a round cambered pattern surface, or an expanding pattern surface, etc.). The pattern surface is near the second display screen 22.

A lower diffusion sheet 13 is installed between the light guiding plate 12 and the first display screen 21. The function of the lower diffusion sheet 13 is to diffuse the light from the light guiding plate 12 to adjust the uniformity of the light so as not to see any reflection image in the first display screen 21.

A first light-enhancing sheet 14 is installed between the lower diffusion sheet 13 and the first display screen 21 for correcting the directivity of the light from the lower diffusion sheet 13 to focus to a predetermined area so as to increase the strength of the light on the first display screen 21.

A second light-enhancing sheet 14 is installed between the light guiding plate 12 and the second display screen 22. No diffusion sheet is installed between the light guiding plate 12 and the second display screen 22. The pattern surface of the light guiding plate 12 has the effect of a diffusion sheet so that light uniformity is increased so as not to see any reflection in the second display screen 22. Light emitted from the pattern surface will incident into the light-enhancing sheet 14 and then is focused by the light-enhancing sheet 14 so as to increase the strength of the light radiated upon the second display screen 22.

Other than reducing the diffusion sheet, the backlight module of the present invention has a pattern surface which is used to replace a reflecting sheet. Thus the loss of light is reduced and the two liquid crystal modules have sufficient light strength. Thereby the sizes of the two liquid crystal modules may be different, the volumes of the two may be larger and cost can be reduced.

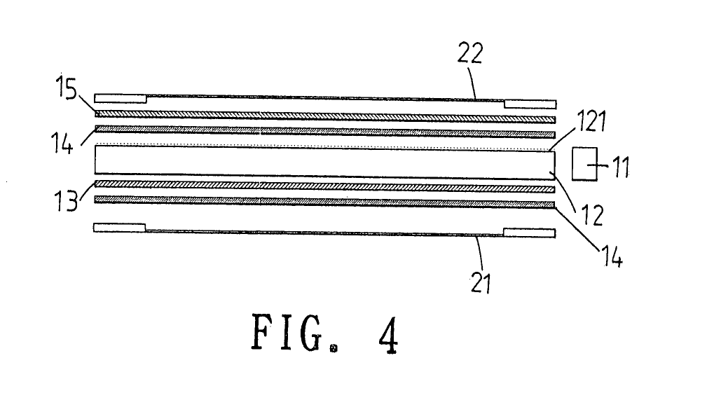

With reference to FIG. 4, the second embodiment of the present invention is illustrated. The difference of this embodiment from the first embodiment is that an upper diffusion sheet 15 is installed between the second light-enhancing sheet 14 and the second display screen 22 so as to prevent Newton circles effect.

With reference to FIG. 5, the third embodiment of the present invention is illustrated. The difference of this embodiment from the first embodiment is that the light guiding plate 12 has a second pattern surface 121 and no lower diffusion sheet 13 is installed between the light guiding plate 12 and the first display screen 21. Thereby the backlight module is lighter.

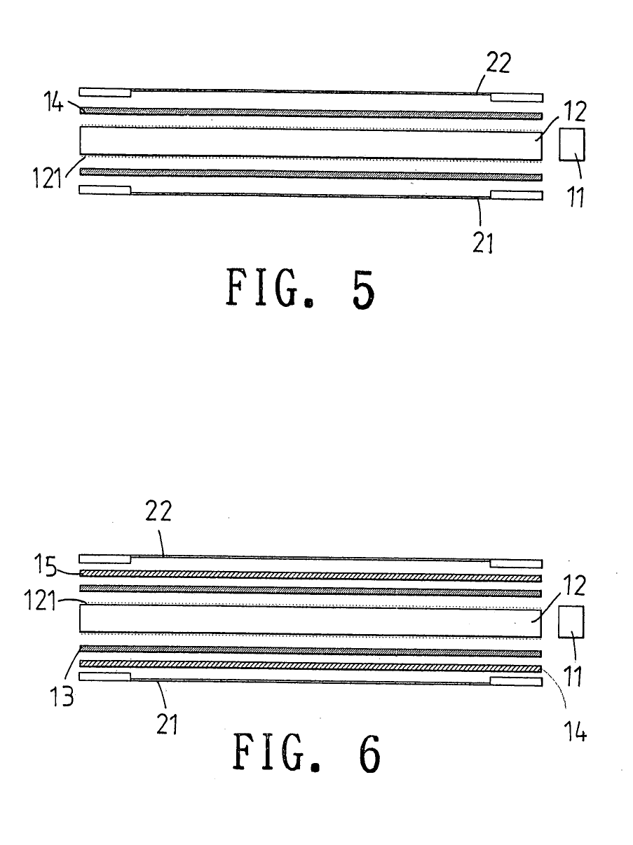

With reference to FIG. 6, the fourth embodiment of the present invention is illustrated. The difference of this embodiment from the first embodiment is that an upper diffusion sheet 15 is installed between the light guiding plate 12 and the light-enhancing sheet 14 so as to avoid Newton circle effects to have a preferred effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A double side backlight module comprising:
a first display screen at a front end;
a second display screen at a back side;
a backlight module unit installed between the first display screen and the second display screen; the backlight module unit having the following elements;
a least one light source;
a light guiding plate having one lateral side adjacent to the at least one light source for guiding light from the light source to the first display screen and second display screen; the light guiding plate having a pattern surface; the pattern surface being near the second display screen;
at least one lower diffusion sheet installed between the light guiding plate and the first display screen; the function of the lower diffusion sheet being to diffuse the light from the light guiding plate to adjust the uniformity of the light so as not to see any reflection image in the first display screen;
at least one first light-enhancing sheet installed between the lower diffusion sheet and the first display screen for correcting the directivity of the light from the lower diffusion sheet;
at least one second light-enhancing sheet installed between the light guiding plate and the second display screen;
wherein no lower diffusion sheet is installed, the pattern surface has the function same as the lower diffusion sheets.

2. The double side backlight module as claimed in claim 1, wherein the light source is selected form one of a cool cathode fluorescent light source (CCFL), light emitting diodes (LED), and an electric luminescence display (ELC).

3. The double side backlight module as claimed in claim 1, wherein first display screen and second display screen are made of optical films.

4. The double side backlight module as claimed in claim 1, wherein the first display screen and second display screen are tightly sealed by light shielding cloth.

5. The double side backlight module as claimed in claim 1, wherein an upper diffusion sheet is installed between the light guiding plate and the light-enhancing sheet near the second display screen.

6. The double side backlight module as claimed in claim 1, wherein at least two first light-enhancing sheets are installed.

7. The double side backlight module as claimed in claim 1, wherein at least two second light-enhancing sheets are installed.

8. The double side backlight module as claimed in claim 1, wherein at least two lower diffusion sheets are installed.

9. The double side backlight module as claimed in claim 1, wherein the pattern surface is selected from one of a V cut pattern surface, a U shape pattern surface, a round cambered pattern surface, and an expanding pattern surface.

10. A double side backlight module comprising:
a first display screen at a front end;
a second display screen at a back side;
a backlight module installed between the first display screen and the second display screen; and the backlight module having the following elements;
a least one light source;
a light guiding plate having one lateral side adjacent to the at least one light source for guiding light from the light source to the first display screen and second display screen; the light guiding plate having two pattern surfaces facing the first display screen and second display screen
at least one first light-enhancing sheet installed between the light guiding plate 91 and the first display screen for correcting the directivity of the light from the lower diffusion sheet;
at least one second light-enhancing sheet installed between the light guiding plate and the second display screen;
wherein no lower diffusion sheets are installed; the pattern surfaces have the function same as the lower diffusion sheet.

11. The double side backlight module as claimed in claim 10, wherein the light source is selected form one of a cool cathode fluorescent light source (CCFL), light emitting diodes (LED), and an electric luminescence display (ELC).

12. The double side backlight module as claimed in claim 10, wherein first display screen and second display screen are made of optical films.

13. The double side backlight module as claimed in claim 10, wherein the first display screen and second display screen are tightly sealed by light shielding cloth.

14. The double side backlight module as claimed in claim 10, wherein an upper diffusion sheet is installed between the light guiding plate and the light-enhancing sheet near the second display screen.

15. The double side backlight module as claimed in claim 10, wherein at least two first light-enhancing sheets are installed.

16. The double side backlight module as claimed in claim 10, wherein at least two second light-enhancing sheets are installed.

18. The double side backlight module as claimed in claim 10, wherein the pattern surfaces are selected from one of a V cut pattern surface, a U shape pattern surface, a round cambered pattern surface, and an expanding pattern surface.
